(19) United States
(12) Patent Application Publication
(10) Pub. No.: US 2024/0246821 A1
(43) Pub. Date: Jul. 25, 2024

(54) Integrated Method For The Decadmiation Of Phosphoric Acid

(71) Applicant: OCP SA, Casablanca (MA)

(72) Inventors: Rabie Labiad, El Jadida (MA); Kamal Samrane, El Jadida (MA)

(73) Assignee: OCP SA, Casablanca (MA)

(21) Appl. No.: 18/266,700

(22) PCT Filed: Dec. 10, 2021
(86) PCT No.: PCT/MA2021/050020

§ 371 Date: Dec. 29, 2023

(30) Foreign Application Priority Data
Dec. 10, 2020 (FR) FR2012986

(51) Int. Cl. C01B 25/222

(52) U.S. Cl. CPC C01B 25/222

(57) ABSTRACT

An integrated method for the decadmiation of phosphoric acid includes: etching phosphate with sulphuric acid in a reactor to prepare a phosphoric acid solution containing cadmium and calcium sulphate dihydrate or hemihydrate; concentrating the phosphoric acid solution to form a concentrated phosphoric acid having a mass content between 42% and 61% of P₂O₅; adding sulphuric acid to adjust the free sulphate content, anhydrate being formed by recrystallisation of the calcium sulphate dihydrate and hemihydrate, the cadmium co-crystallising with the anhydrite, to obtain decadmiated phosphoric acid and cadium-rich anhydrite sludge; desulphating the decadmiated phosphoric acid; desaturating and clarifying by decanting the mixture of decadmiated phosphoric acid and sludge; conditioning the sludges with a phosphoric acid solution having a titre by mass of less than or equal to 61% of P₂O₅; and recycling the conditioned sludge in the phosphate etching step.

### FIELD OF THE INVENTION

The present invention relates to an integrated method for decadmiation of phosphoric acid by co-crystallization of cadmium in the crystal lattice of calcium sulfate anhydrite.

### STATE OF THE ART

Phosphoric acid (H₃PO₄) is an essential product in the manufacture of fertilizers, in particular ternary NPK fertilizers, or binary NP fertilizers, as well as triple superphosphate (TSP).

Phosphoric acid after purification is also used in the manufacture of food products, in particular for the acidification of beverages, or for the treatment of metal surfaces, in the field of microelectronics or in the pharmaceutical field.

Phosphate rocks are important sources of raw material for the manufacture of phosphoric acid. Phosphoric acid can be produced mainly by two methods: wet method and thermal method. The wet method is the most used and the phosphoric acid from this route can be used to produce phosphate fertilizers (DAP or diammonium phosphate, MAP or monoammonium phosphate, TSP or triple superphosphate). The acid obtained by thermal method is of higher purity and it is generally used for pharmaceutical products or food products.

In a wet method production unit, phosphoric acid is produced in particular by the action of a strong acid on natural phosphate ore. Sulfuric acid is the most commonly used strong acid. In this case, insoluble calcium sulfate is formed which is separated by filtration to recover said insoluble calcium sulfate. The operating conditions are chosen in order to precipitate the calcium sulfate either in its dihydrate form (phosphogypsum), producing phosphorus pentoxide P₂O₅ generally at a concentration of 26-32% at 70-80° C., or in its hemihydrate form, with P₂O₅ generally at a concentration of 40-52% at 90-110° C. Evaporation can be used to further concentrate the phosphoric acid later and thus optimize its quality.

The presence of impurities in phosphoric acid influences the operation of phosphoric acid manufacturing units and the quality of finished products. In particular, several works on the subject highlight the effect of impurities contained in phosphoric acid on corrosion and fouling of equipment, as well as on the viscosity and coloring of the acid.

Other work has revealed the toxic effect of certain impurities in products using phosphoric acid as an intermediate product.

Cadmium is one of the elements that have experienced strong restrictions at limit contents in phosphate and in derivative products. Indeed, during the manufacture of phosphoric acid by the wet method using sulfuric acid, the impurities originating from the phosphate rock are distributed between phosphoric acid and calcium sulfate.

Phosphate manufacturers are therefore increasingly confronted with regulatory restrictions with regard to certain elements present in their products. Heavy metals, and especially cadmium (Cd), are subject to regulations which limit their content in phosphate and phosphate derivatives.

With regard to cadmium, in addition to the limit content set at 60 mg/kg P₂O₅, the European Union is preparing to set up a low cadmium content label applicable to products whose cadmium content is lower than 20 mg/kg P₂O₅.

In this context, the development of efficient decadmiation methods, that is to say allowing to greatly reduce the amount of cadmium in the phosphated product, and very particularly in the phosphoric acid, is therefore decisive.

To this end, the document FR2687657 describes a method for decadmiation of a phosphoric acid solution based on an adjustment of the solid level and sulfuric acid in an evaporator reactor operating at a temperature ranging from 84° C. to 92° C. This adjustment is made for a solid level comprised between 1.3 and 6% in order to have an excess of free calcium sulfate between 1.5 and 6%, allowing to have a phosphoric acid with a Cd content of less than 10 ppm.

Document WO2014027348 describes a method for manufacturing phosphoric acid with a reduced content of cadmium and calcium sulfate, which method comprises the steps which consist in mixing crude phosphoric acid, having a P₂O₅ concentration between 45 and 55% and containing up to 50 ppm of cadmium, with concentrated sulfuric acid, in order to obtain a calcium sulfate concentration of 4 to 12%; adding 5 to 15% natural phosphate rock to the mixture, so as to obtain phosphoric acid and suspended particles of calcium sulfate; then filtering said particles at a temperature of at least 80° C. However, this method is characterized by the generation of a large amount of sludges leading to a significant loss of phosphoric acid, which affects the overall cost of the method and complicates operability. This cadmium sludges are filtered on a sludge filter or slurry filter. However, the very fine characteristic of the solid generated, and the dynamic viscosity of the cadmium sludges, lead to enormous filtration difficulties inducing significant losses of P₂O₅, in addition to significant clogging of the filter.

Document WO2008113403 describes a method for treating cadmium-bearing solids including calcium sulfate anhydrite and/or hemihydrate having a cadmium content, characterized in that it comprises an extraction of cadmium from said cadmium-bearing solids by contacting them with an alkali metal sulfate aqueous solution, and a solid/liquid separation between a solid phase based on calcium sulfate dihydrate with a depleted cadmium content with respect to said cadmium content of the calcium sulfate anhydrite and/or hemihydrate and an aqueous phase containing alkali metal sulfate and cadmium in solution. However, this method, which focuses on the problem of managing cadmium sludges by filtration then extraction of cadmium from solid calcium sulfate, does not provide a solution to the P₂O₅ losses induced by the filtration of cadmium sludges.

Document EP0253454 describes a method for removing cadmium from phosphoric acid, based on the co-crystallization of cadmium in calcium sulfate anhydrite. This method, specially designed for the hemihydrate and phosphonitric acid methods, only seems to apply to low-concentration acids (44% P₂O₅ by weight) and at temperatures ranging from 90 to 110° C. In addition, this method uses a solid level of 10%, for an acid at 44% P₂O₅ by weight. Decadmiation takes place in the presence of a significant sulfuric excess of 8% (for a 44% P₂O₅ acid), which requires desulfation after decadmiation. The desulfation is carried out by adding phosphate under conditions which have not been indicated. However, this method generates a discharge of cadmium-containing sludges that is bulky and not very concentrated, which is subsequently filtered and leads to losses of P₂O₅.

Document WO1991000244 describes a method allowing the elimination of cadmium by co-crystallization of a precipitate based on calcium, cadmium, sulfate and phosphate ions. This method uses 50-60% P₂O₅ concentrated acid, in the presence of a sulfuric excess of 1 to 7% and at high temperature (120° C.). The calcium is introduced in a soluble form obtained by etching phosphate with concentrated phosphoric acid at 120° C. However, this method, in addition to the complication generated by the multitude of reactors used, requires a very high temperature in a phosphosulfuric medium, which would require the use of noble and consequently expensive materials. The problem of managing decadmium sludges by filtration remains a weak point of the method with respect to operability and P₂O₅ losses.

Document MA23803 describes a method for the production of decadmiated phosphoric acid by co-crystallization of cadmium with calcium sulfate. Decadmiation takes place on the acid at the outlet of the concentration step, at the temperature of this acid. According to this method, the decadmiation conditions consist of the introduction into the (45-60% P₂O₅) concentrated acid of calcium sulfate in hemihydrate or dihydrate form at a solid level varying between 0.5 and 10% and readjusting the sulfuric level of phosphoric acid at a content comprised between 60 and 120 g/L. The temperature can vary between that of the acid at the outlet of the concentration step and 50° C. Desulfation takes place in the presence of phosphate. The decadmiation sludges and this desulfation can be recycled to the etching tank, to the calcium sulfate filter, or can be separated by conventional separation methods such as decantation, filtration and/or centrifugation for their processing or storage. However, this method does not provide an operational and economical solution for the management of cadmium-containing sludges by recycling to the etching tank or to the calcium sulfate filter. Indeed, in the phosphoric acid production industry, the recycling of calcium phosphate sludges with 45 to 60% P₂O₅ from the settling outlet to the rock etching tank, induces a significant loss of syncrystallized P₂O₅ due to the high viscosity of the sludges, also there is a negative impact on the filtration following the deterioration of the crystallization of the calcium sulfate by adding a large amount of hemihydate and anhydrite crystals known for their poor morphology and filtration. Recycling on the filter reduces the filtration speed of the calcium sulfate slurry, by clogging the filter cloth due to the fineness of the hemihydrate and anhydrite solid particles brought by the sludges, and by the viscosity of the sludges.

### DISCLOSURE OF THE INVENTION

An object of the invention is to propose an integrated method for the decadmiation of phosphoric acid allowing to overcome the disadvantages described above.

The invention proposes an integrated method for the decadmiation of phosphoric acid by co-crystallization of cadmium in the crystal lattice of calcium sulfate anhydrite, allowing, compared to the methods of the state of the art, to minimize the losses of P₂O₅, to obtain a very high decadmiation yield and a high P₂O₅ concentration of the decadmiated phosphoric acid at the end of the method.

More specifically, the invention proposes an integrated method for the decadmiation of phosphoric acid, comprising the following steps:
etching phosphate with sulfuric acid in a reactor so as to prepare a phosphoric acid solution containing cadmium and calcium sulfate dihydrate or hemihydrate,
concentrating said phosphoric acid solution, so as to form a concentrated phosphoric acid having a mass content between 42% and 61% of P₂O₅, preferably between 48% and 61%,
adding sulfuric acid to concentrated phosphoric acid in order to adjust the free sulfate content in the mixture of sulfuric acid and phosphoric acid to a content comprised between 1.5% and 10% by weight of the mixture, preferably between 2.5% and 9% by weight of the mixture, anhydrite being formed by recrystallization of the calcium sulfate dihydrate and hemihydrate, the cadmium co-crystallizing with said anhydrite, so as to obtain decadmiated phosphoric acid and cadmium-rich anhydrite sludges,
desulfating the decadmiated phosphoric acid, in the presence of phosphate to have in said phosphoric acid a solid level comprised between 1 and 15% by weight, preferably 7% by weight, and a sulfate level comprised between 1% and 5% by weight, preferably 3% by weight;
desaturating and clarifying by decanting the mixture of decadmiated phosphoric acid and cadmium-rich anhydrite sludge, in order to separate the final phosphoric acid (P_{L}u) having a cadmium content of less than 10 ppm, even of less than 2 ppm, and cadmium-rich sludges,
conditioning said cadmium-rich anhydrite sludges with a phosphoric acid solution having a titer by mass of less than or equal to 61% of P₂O₅,
recycling the conditioned sludge in the step of etching phosphate with sulfuric acid.

“Integrated” means in this text that the decadmiation method is incorporated into a phosphoric acid and fertilizer production line, in the sense that the transfers of flows (phosphate, phosphoric acid, sulfuric acid, water, steam, sludges, . . . ) are operated and managed as part of a single transformation chain. In other words, the decadmiation method, object of the present invention, is an integral part of the manufacturing chain of phosphoric acid and fertilizers.

According to advantageous but optional characteristics, optionally taken in combination:
the decadmiation and desulfation steps are implemented simultaneously;
the decadmiation and desulfation steps are implemented successively;
the decadmiation of the phosphoric acid is carried out at a temperature comprised between 50 and 120° C., preferably above 70°;
the decadmiation of the phosphoric acid and the desulfation of the decadmiated phosphoric acid are carried out in a single reactor;
the decadmiation of the phosphoric acid is carried out at a pressure comprised between 10⁴ and 10⁵ Pa;
the step of conditioning the cadmium-rich anhydrite sludges comprises adjusting the cadmium content, the P₂O₅ content, the solid level, the temperature and/or the viscosity of said sludges;
in the conditioning step, the cadmium-rich anhydrite sludges have a temperature comprised between 40 and 60° C., preferably equal to 50° C., and a solid level comprised between 5 and 25%, preferably equal to 10%;
in the conditioning step, the phosphoric acid solution has a titer by mass of less than 30% of P₂O₅, preferably of less than 20% of P₂O₅, and more preferably of less than 10% of P₂O₅;
to mix the cadmium-rich anhydrite sludges with the phosphoric acid solution, said phosphoric acid solution (PA_{d}) is at a temperature greater than or equal to 40° C., preferably greater than 50° C., and more preferably greater than 60° C.;
the conditioned sludges have a temperature comprised between 40 and 80° C., preferably equal to 47° C., and a solid level comprised between 5 and 20% by weight, preferably equal to 10%;
during the recycling step, the conditioned sludges are introduced into the reactor for etching phosphate with sulfuric acid;
during the recycling step, the conditioned sludges are filtered with calcium sulfate dihydrate or hemihydrate obtained by the reaction of etching the phosphate with phosphoric acid.

### BRIEF DESCRIPTION OF THE FIGURES

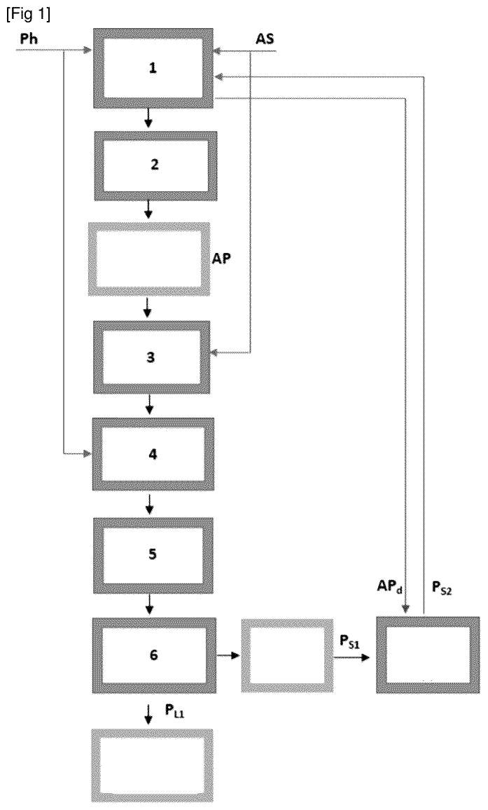

Other advantages and characteristics of the invention will appear upon reading the following description given by way of illustrative and non-limiting example, with reference to FIG. 1 which is a diagram illustrating the main steps of the phosphoric acid decadmiation method according to the invention.

### DETAILED DESCRIPTION OF EMBODIMENTS

The invention relates to an integrated method for the decadmiation of phosphoric acid by co-crystallization of cadmium in the crystal lattice of calcium sulfate anhydrite, allowing, compared to the methods of the state of the art, to minimize the losses of P₂O₅, to obtain a very high decadmiation yield and a high P₂O₅ concentration of the decadmiated phosphoric acid at the end of the method.

According to a first step of the method, referenced 1 in FIG. 1, a phosphoric acid solution is prepared containing cadmium and insoluble calcium sulfate, which can be dihydrate or hemihydrate, according to the method for the production of phosphoric acid. For this purpose, sulfuric acid is reacted with natural phosphate ore.

According to the dihydrate method, sulfuric acid (SA) is reacted in a first reactor with phosphate ore (Ph). Preferably, it is natural phosphate ore.

Reaction (a) is as follows, and leads to the formation of phosphoric acid H₃PO₄ and phosphogypsum CaSO₄(H₂O)₂ and hydrofluoric acid HF:

Ca₅(PO₄)₃F+5H₂SO₄+10H₂O→3H₃PO₄+5CaSO₄·2H₂O+HF (a)

After reaction, the mixture is filtered. A filtrate comprising phosphoric acid, and a residue in the filter comprising calcium sulfate dihydrate are recovered.

Then, a step of concentrating the phosphoric acid obtained, referenced 2 in FIG. 1, is carried out so that the titer by weight of the phosphoric acid is comprised between 42% and 61% of P₂O₅, preferably between 48% and 61% of P₂O₅. This concentration step is integrated into the decadmiation method. This allows to avoid having recourse to an evaporator reactor, thus reducing the cost of the method.

The phosphoric acid (PA), optionally decanted, has a solid level of less than 6% by weight, or even of less than 4% by weight relative to the weight of the phosphoric acid solution.

According to the hemihydrate method, sulfuric acid (SA) is reacted in a first reactor with phosphate ore (Ph), the temperature being from 90° C. to 100° C. Preferably, it is natural phosphate ore.

Reaction (b) is as follows, and leads to the formation of phosphoric acid H₃PO₄ and calcium sulfate hemihydrate CaSO_{4 1/2} (H₂O) and hydrofluoric acid HF:

Ca₅(PO₄)₃F+5H₂SO₄+5/2H₂O→3H₃PO₄+5CaSO₄·½H₂O+HF (b)

After reaction, the mixture is filtered. A filtrate comprising the phosphoric acid, and a residue in the filter comprising the calcium sulfate hemihydrate are recovered.

Then, the acid can be treated as it is, which has a title by weight of phosphoric acid between 40% and 50%, or a step of concentrating the phosphoric acid obtained is carried out, so that the title by weight of the phosphoric acid is comprised between 50% and 61% of P₂O₅. This allows to avoid having recourse to an evaporator reactor, thus reducing the cost of the method.

The phosphoric acid (PA), optionally decanted, has a solid level of less than 6% by weight, or even of less than 4% by weight relative to the weight of the phosphoric acid solution.

The concentration step is typically carried out at a temperature comprised between 70 and 80° C.

Regardless of the method (dihydrate or hemihydrate), the phosphoric acid (PA) is then readjusted by adding sulfuric acid (SA), in order to have a level of free sulfate comprised between 1.5% and 10% by weight, preferably between 2.5% and 9% by weight, in the mixture obtained. This is the step of decadmiation by co-crystallization, referenced 3 in FIG. 1. Decadmiation can take place in a single, or even several reactors. Decadmiation is carried out at a temperature comprised between 50 and 120° C., preferably above 70° C. in order to allow the formation of anhydrite, that is to say anhydrous calcium sulfate CaSO₄, by recrystallization of the calcium sulfate dihydrate and hemihydrate.

Because the phosphoric acid obtained in the concentration step has a certain sulfate content, the consumption of sulfuric acid can be minimized during the decadmiation method.

During the decadmiation reaction, the cadmium becomes trapped in the crystals of the anhydrite. In other words, cadmium co-crystallizes with anhydrite resulting from recrystallization of the calcium sulfate dihydrate and hemihydrate. Cadmium-rich anhydrite sludges, separable from the decadmiated phosphoric acid, is thus obtained.

The desulfation of the decadmiated phosphoric acid solution (step 4 in FIG. 1) takes place in the presence of the phosphate. The amount of phosphate to add depends on its CaO content and the sulfate content to be achieved. According to this method, the phosphate is introduced into the phosphoric solution to have a solid level comprised between 1 and 15% by weight, preferably 7% by weight, and a sulfate level comprised between 1% and 5% by weight, preferably 3% by weight.

The method allows decadmiation and desulfation simultaneously or separately. Indeed, it takes advantage of the difference that exists between the kinetics of decadmiation and desulfation. Decadmiation and desulfation can take place in a single reactor, which greatly simplifies the method.

Furthermore, since the temperature of the phosphoric acid is high during the concentration step, additional heating energy is thus saved during the decadmiation and the subsequent steps of the method.

Steps 5 and 6 in FIG. 1 correspond respectively to the desaturation and clarification by decantation of the mixture of decadmiated phosphoric acid and cadmium-rich anhydrite sludges, in order to separate the final phosphoric acid (P_{L}u) having a cadmium content of less than 10 ppm, or even of less than 2 ppm following the co-crystallization of cadmium in the anhydrite crystals, and the cadmium-rich sludges (Psi) consisting mainly of anhydrite crystals.

Decadmiation is carried out at atmospheric pressure, that is to say a pressure of 1 atmosphere or 760 mmHg (10⁵ Pa), or even at a negative pressure of up to 80 mmHg (10⁴ Pa).

The liquid phase P_{L1} represents the final phosphoric acid with a low cadmium content obtained from the integrated decadmiation method. It is recovered and may possibly undergo other subsequent treatments.

Cadmium-rich sludges (P_{S1}), having a temperature comprised between 40 and 60° C., preferably of the order of 50° C., a solid level comprised between 5 and 25%, preferably of the order of 10% undergo a conditioning treatment, step 7 in FIG. 1, by mixing with a solution of dilute phosphoric acid (PA_{d}) having a P₂O₅ titer of less than or equal to 61% of P₂O₅. Preferably, a dilute phosphoric acid solution is used whose titer by mass is of less than 30% of P2O5, preferably of less than 20% of P2O5, and more preferably of less than 10% of P2O5.

The temperature of the dilute phosphoric acid solution (PA_{d}) is above 40° C., preferably above 50° C., and more preferably above 60° C.

The conditioning treatment of cadmium-rich sludges consists of adjusting the composition of the cadmium-rich sludges in terms of cadmium content, P₂O₅ content, solid level, temperature and viscosity.

The conditioned sludges thus obtained (P_{S2}), having a temperature comprised between 40 and 80° C., preferably of the order of 47° C., and a solid level comprised between 5 and 20% by weight, preferably of the order of 10%, are recycled to the phosphate etching step (step 1 in FIG. 1), where they are introduced into the etching reactor, or filtered at the filtration operation, directly in mixture with the slurry of the calcium sulfate dihydrate or hemihydrate obtained at the etching reaction of the phosphate,

This sludge conditioning treatment mode is an integrated technical solution for the management of cadmium-rich sludge, which allows to minimize P₂O₅ losses, reduce the investment and footprint of the installation, as well as increase the P₂O₅ titer at the phosphoric acid preparation step, and the P₂O₅ yield of the integrated decadmiation method.

The sludge conditioning treatment mode therefore solves all the cadmium-containing sludge management problems presented in previous patents, namely the P₂O₅ losses during the filtration of the sludges (P₂O₅ yield), the investment in filtration, footprint of the installation, management of the cadmium-rich solid anhydrite cake after filtration of the sludges, known for its rapid solidification and its great hardness, which poses evacuation difficulties.

The integrated decadmiation method according to the invention allows to have a P₂O₅ yield greater than 99% following the conditioning and recycling treatment of the conditioned sludges.

### EXAMPLES

The following non-limiting examples illustrate embodiments of the invention. The percentages given are all mass percentages.

### Example 1

In a phosphoric acid solution having a composition of 52% of P₂O₅, 3% of solid, 2% of sulfates and containing 38 mgCd/KgP₂O₅, 67 g of 98% sulfuric acid are introduced to bring the sulfates to 6%. The temperature is maintained at 70° C.

After decantation of the decadmiated acid, the cadmium content in the phosphoric acid is 8 mgCd/KgP₂O₅ with a solid level of 0.5% and a sulfate level of 1%. The sludges after conditioning are recycled in the phosphate etching. The P₂O₅ yield of the integrated decadmiation method is 99.5%.

### Example 2

In a phosphoric acid solution having a composition of 50% of P₂O₅, 6% of solid, 3% of sulfates and containing 60 mgCd/KgP₂O₅, 83 g of 98% sulfuric acid are introduced to bring the sulfates to 8%. The temperature is maintained at 80° C.

After decantation of the decadmiated acid, the cadmium content in the phosphoric acid is 3 mgCd/KgP₂O₅ with a solid level of 0.5% and a sulfate level of 1%. The sludges after conditioning are recycled in the phosphate etching. The P₂O₅ yield of the integrated decadmiation method is 99%.

### Example 3

Cadmium-rich sludges characterized by a temperature of 53° C., a P₂O₅ titer of 44%, a solid level of 20%, a sulfate level of 0.8% and a cadmium content of 85 ppm, are conditioned by mixing with dilute phosphoric acid according to a ratio of 35 shares of phosphoric acid to one share of sludges (35/1 m/m), the phosphoric acid is fed at a temperature of 65° C., a P₂O₅ titer of 28%, a solid level of 5%, a sulfate level of 2% and a cadmium content of 12 ppm. The sludges thus conditioned are characterized by a temperature of 47° C., a solid level of 6% by weight and a cadmium content of 56 ppm. They are then recycled to the phosphate etching reactor.

### REFERENCES

FR2687657
WO2014027348
WO2008113403
EP0253454
WO1991000244
MA23803

1. An integrated method for decadmiation of phosphoric acid, comprising
a decadmiation comprising:
etching phosphate with sulfuric acid in a reactor to prepare a phosphoric acid solution containing cadmium and calcium sulfate dihydrate or hemihydrate,
concentrating said phosphoric acid solution, so as to form a concentrated phosphoric acid having a mass content between 42% and 61% of P₂O₅, preferably between 48% and 61%,
adding sulfuric acid to concentrated phosphoric acid in order to adjust the free sulfate content in the mixture of sulfuric acid and phosphoric acid to a content comprised between 1.5% and 10% by weight of the mixture, preferably between 2.5% and 9% by weight of the mixture, anhydrite being formed by recrystallization of the calcium sulfate dihydrate and hemihydrate, the cadmium co-crystallizing with said anhydrite, so as to obtain decadmiated phosphoric acid and cadmium-rich anhydrite sludges,
and a desulfation comprising:
desulfating the decadmiated phosphoric acid, in the presence of phosphate to have in said phosphoric acid a solid level comprised between 1 and 15% by weight, preferably 7% by weight, and a sulfate level comprised between 1% and 5% by weight, preferably 3% by weight; and
desaturating and clarifying by decanting the mixture of decadmiated phosphoric acid and cadmium-rich anhydrite sludge, in order to separate the final phosphoric acid having a cadmium content of less than 10 ppm, even of less than 2 ppm, and cadmium-rich sludges,
conditioning said cadmium-rich anhydrite sludges with a phosphoric acid solution having a titer by mass of less than or equal to 61% of P₂O₅, and
recycling the conditioned sludges in the step of etching the phosphate with sulfuric acid.

2. The method according to claim 1, wherein the decadmiation and the desulfation are carried out simultaneously.

3. The method according to claim 1, wherein the decadmiation and the desulfation are carried out successively.

4. The method according claim 1, wherein the decadmiation of the phosphoric acid is carried out at a temperature comprised between 50 and 120° C., preferably above 70°.

5. The method according to claim 1, wherein the decadmiation of the phosphoric acid and the desulfation of the decadmiated phosphoric acid are carried out in a single reactor.

6. The method according to claim 1, wherein the decadmiation of the phosphoric acid is carried out at a pressure comprised between 10⁴ and 10⁵ Pa.

7. The method according to claim 1, wherein the conditioning the cadmium-rich anhydrite sludges comprises adjusting the cadmium content, the P₂O₅ content, the solid level, the temperature and/or the viscosity of said sludges.

8. The method according to any claim 1, wherein, during conditioning, the cadmium-rich anhydrite sludges have a temperature comprised between 40 and 60° C., and a solid level comprised between 5 and 25%.

9. The method according to claim 1, wherein, during conditioning, the phosphoric acid solution has a titer by mass of less than 30% of P₂O₅.

10. The method according to claim 1, wherein, in order to mix the cadmium-rich anhydrite sludges with the phosphoric acid solution, said phosphoric acid solution is at a temperature greater than or equal to 4° C.

11. The method according to claim 1, wherein the conditioned sludges have a temperature comprised between 40 and 80° C., and a solid level comprised between 5 and 20% by weight.

12. The method according to claim 1, wherein, during recycling, the conditioned sludges are introduced into the reactor for etching phosphate with sulfuric acid.

13. The method according to claim 1, wherein, during recycling, the conditioned sludges are filtered with calcium sulfate dihydrate or hemihydrate obtained by the reaction of etching the phosphate with phosphoric acid.
